(19) United States
(12) Patent Application Publication
(10) Pub. No.: US 2002/0038823 A1
(43) Pub. Date: Apr. 4, 2002

(54) Cooking oil spray dispenser

(76) Inventor: Pierre Tardif, Longueuil (CA)

Correspondence Address: DARBY & DARBY, 805 THIRD AVENUE, 27TH FLR., NEW YORK, NY, 10022, US

(21) Appl. No.: 09/965,666

(22) Filed: Sep. 26, 2001

(30) Foreign Application Priority Data
Sep. 26, 2000 (CA) 2,320,653

(51) Int. Cl. G01F 11/06

(52) U.S. Cl. 239/333; 222/331; 222/329

(57) ABSTRACT

The cooking oil spray dispenser has a container for receiving the cooking oil. A spraying mechanism is mounted on the upper end of the container for picking up and spraying the cooking oil. The spraying mechanism includes a tube through which the cooking oil is picked up from the container. This tube extends within the container and has an open lower end to which is fixed a filtering device having a central hub and a base with rim. The central hub is shaped to fit onto the lower end of the tube while the base acts as a support for a mesh which is supported by the rim of the base. In use, the mesh prevents clogging of the lower end of the tube with solid materials such as spices or herbs that may be contained in the cooking oil. Preferably, the mesh is a micromesh and has a convex shape. Such further reduces the risk of clogging since the herbs or spices cannot attach to the micromesh and thus cannot close the inlet of the tube.

### FIELD OF THE INVENTION

The present invention relates to a spray dispenser for use to spray a cooking oil. More specifically, the invention relates to a spray dispenser for a cooking oil which contains solid materials such as spices, herbs or the like.

### BACKGROUND OF THE INVENTION

Numerous spray dispensers are presently available, which comprise a spraying mechanism of the button-activated or trigger actuated type, with a tube dipping into the liquid to be sprayed. Such dispensers are mainly used for spraying cleaning products or water. In some embodiments especially designed for spraying water onto plants, the bottom end of the tube may be provided with a plug incorporating a grid to prevent leaves or branches present in the water from being sucked in. However, it does not and cannot retain small particles.

It has already been suggested to use similar dispensers for cooking purpose. Indeed, it may be very useful to spray vegetable oil or the like onto a spraying pan to <<oil >> the same instead of using butter or to spray oil onto food while it is cooked.

While these spray dispensers known in the art have good acceptance and appeal for the consumers which use conventional cooking oil, a problem arises when the cooking oil contains spices or herbs which are usually of a very small size. Indeed, clogging occurs due to an accumulation of the spices and/or herbs within the tube and the consumer must clean the dispensing device or use the remaining oil in some less convenient or efficacious way.

Therefore, there is a need for a cooking oil spray dispenser which efficiently prevents clogging of the tube dipping in the cooking oil when said oil contains spice or herbs.

### SUMMARY OF THE INVENTION

The object of the present invention is to fulfil the above mentioned need by providing a cooking oil spray dispenser of the type comprising a container for receiving the cooking oil, the container having an upper end. Spraying means is mounted on the upper end of the container for picking up and spraying the cooking oil. The spraying means includes a tube through which the cooking oil is picked up from the container. This tube extends within the container and has an open lower end.

In accordance with the invention, the dispenser further comprises a filtering device comprising a central hub and a base with a rim. The central hub is shaped to fit onto the lower end of the tube while the base acts as a support for a mesh which is supported by the rim of said base.

In use, this mesh prevents clogging of the lower end of the tube with solid materials that may be contained in the cooking oil.

In accordance with a particularly preferred embodiment of the invention, the mesh is a micromesh and has a convex shape. This embodiment further reduces the risk of clogging since the herbs or spices cannot <<attach >> to the micromesh and thus cannot <<close >> the inlet of the tube.

The present invention and its advantages will be more easily understood after reading the following non-restrictive description of a preferred embodiment thereof, made with reference to the following drawings.

### BRIEF DESCRIPTION OF THE DRAWINGS

FIG. 1 is a partial cross-sectional view of a spray dispenser for cooking oil spray according to a preferred embodiment of the invention.

FIG. 2 is a cross-sectional view of a first embodiment of the filtering device of the dispenser shown in FIG. 1.

FIG. 3 is a cross-sectional view of a second embodiment of the filtering device of the dispenser shown in FIG. 1.

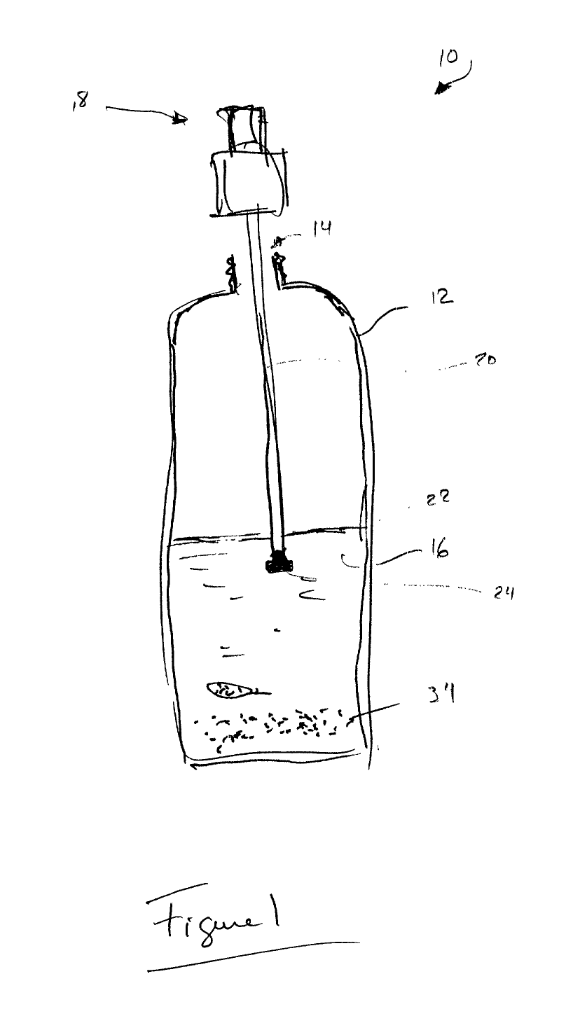

### DESCRIPTION OF A PREFERRED EMBODIMENT

The cooking oil dispenser (10) according to the preferred embodiment of the invention as shown in the accompanying drawings comprises a container (12) with an upper end (14) shaped to define an open neck. The container (12) is devised to receive and store a cooking oil (16). The dispenser (10) also comprises spraying means (18) detachably mounted by screwing or snapping onto the upper end (14) of the container 912). The spraying means comprises a mechanism for spraying the cooking oil (16). The spraying means (18) also comprises a tube (20) extending vertically within the container (1) and provided with a lower end (22) through which the oil can be sucked up. The spraying mechanism of the spraying means (18) may be of conventional type. It may, for example, be of the button-actuated type, as shown. Alternatively, it may be of the trigger-actuated type. As a matter of fact, a present invention may be used with any type of spraying means that are known to those skilled in the field of the invention.

As aforesaid, the above basic structure is known per se and needs not be further detailed.

In accordance with the invention, the dispenser (10) is characterized in that it further comprises a central hub (26) and a base (28) with a rim (30). The central hub (26) is shaped to fit to the lower end (22) of the tube (20). The base (10) is devised to act as a support for a mesh (32) which is supported by the rim (30) of the base (28). The purpose of the mesh (32) is to prevent clogging of the lower end (22) of the tube (20) with solid materials (34) such as herbs or spices contained in the cooking oil (16).

As a mesh (32), use is preferably made of a micromesh with very small holes. In practice, the size of the holes should be small enough to prevent solid materials contained in the cooking oil from attaching to the mesh and clogging the tube.

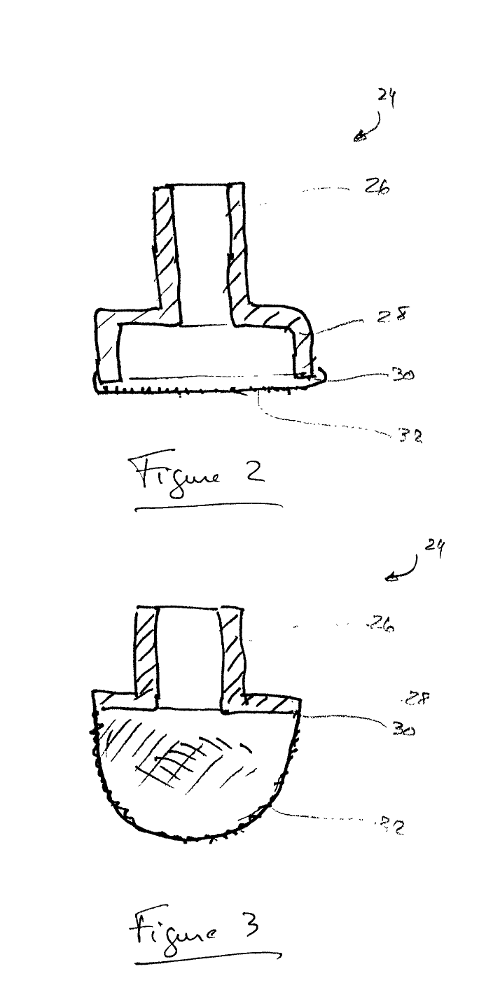

According to a first preferred embodiment of the invention, the mesh has a substantially flat shape and extends in the same plane as the rim of the base (FIG. 2). According to another more preferred embodiment of the invention, the mesh is substantially convex shape and projects downwardly from the rim of the base (FIG. 3).

Such a particular shape and positioning given to the mesh allow easy cleaning or declogging of the mesh when solid materials are covering it. Indeed, the consumer only has to gently shake the dispenser (10) to cause the solid materials in contact with the mesh from detaching from the same.

Although preferred embodiments of the present invention have been described in detail herein and illustrated in the accompanying drawings, it is to be understood that the invention is not limited to these embodiments and that various changes and modifications could be made without departing from the scope and spirit of the present invention.

1. A cooking oil spray dispenser comprising:
a container for receiving said cooking oil, said container having an upper end;
spraying means mounted on the upper end of said container for picking up and spraying the cooking oil from the container, said tube extending within the container and having an open lower end; and
a filtering device comprising a central hub and a base with a rim, said central hub being shaped to fit onto the lower end of the tube, said base acting as a support for a mesh, said mesh being supported by the rim of said base,
whereby said mesh prevents clogging of the lower end of the tube with solid materials that may be contained in the cooking oil.

2. A dispenser according to claim 1, wherein the spraying means is of a button-actuated type.

3. A dispenser according to claim 1, wherein the spraying means is of trigger actuated type.

4. A dispenser according to claim 1, 2 or 3, wherein the mesh has a substantially flat shape.

5. A dispenser according to claim 1, 2 or 3, wherein the mesh has a substantially convex shape.

6. A dispenser according to any one of claims 1 to 5, wherein the mesh is a micromesh.
